(19) United States
(12) Patent Application Publication
(10) Pub. No.: US 2006/0122956 A1
(43) Pub. Date: Jun. 8, 2006

(54) Electronic document management apparatus and electronic document management program

(75) Inventor: Nobuhiro Shimogori, Kawasaki-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 11/003,899

(22) Filed: Dec. 3, 2004

(51) Int. Cl. G06F 17/30

(52) U.S. Cl. 707/1

(57) ABSTRACT

An electronic document management apparatus is provided which can efficiently display the existence state of entire electronic documents stored so as to easily search for a target electronic document in a visual manner. In the electronic document management apparatus of the present invention, a document map creation section represents document files, which have been sorted according to a prescribed rule by means of a file sort section, by prescribed segments, respectively, and connects these segments with one another to form a band-shaped document map, and provides each segment with a classification color indicative of the classification of a group of document files from a color acquisition section.

### BACKGROUND OF THE INVENTION

1. Field of the Invention

The present invention relates to an electronic document management apparatus and program, and more specifically, to an electronic document management apparatus and an electronic document management program capable of efficiently finding out where a target electronic document exists from among a multitude of electronic documents stored in a storage device.

2. Description of the Related Art

When a target document is searched for based on the registered information of electronic documents (hereinafter usually described as documents) registered in a database or an electronic document management apparatus, if the documents to be searched are distributed on the basis of certain criteria, knowing the distribution state of the documents is very effective in increasing search efficiency. In actuality, when beginning to do new searches, a person with much experience of search performs effective searches by making searches with several keywords and then narrowing the position of distribution to be selected from the number of search hits. In this case, considering the characteristic of human information processing ability, it is easy for one to grasp the whole of the state of distribution by a visual representation of distribution rather than by a character representation of distribution.

Accordingly, visual search methods have been proposed in consideration of the characteristic of human information processing ability as stated above. Such proposals roughly include two methods of representation; one is a method of displaying information to be searched in a two-dimensional space, and another is a method of sorting documents based on a described criterion, and displaying the thus sorted state on a one-dimensional straight line. These methods are disclosed in a patent document of Japanese patent application laid-open No. H11-328209 (summary, pages 4-6 and FIGS. 5-8). In the image search apparatus and methods, pieces of date information on image data are marked on the time axis so as to display the distribution of the information.

However, in the above-mentioned prior art, there is the following problem. That is, by merely marking the positions of pieces of information on the time axis, it is impossible to represent the case where a multitude of pieces of data are overcrowded at the same period of time, as a consequence of which efficient searches cannot be done by using a display area without waste.

### SUMMARY OF THE INVENTION

The present invention is intended to obviate the problem as referred to above, and has for its object to provide an electronic document management apparatus and program capable of efficiently displaying the state of existence of entire stored electronic documents in a display area so as to visually easily predict the positions of existence of electronic documents to be searched for, whereby when any electronic document is selected, the content thereof can also be verified.

In order to solve the above-mentioned problem, the present invention resides in a electronic document management apparatus which comprises: a file sort section that reads individual document files from a plurality of document files storing electronic documents, and sorts the document files thus read according to a prescribed rule; a color management section that associates a classification color assigned corresponding to a group, to which each document file belongs, with document files which belong to that group; and a document map creation section that represents each document file by a segment of a predetermined length and of a predetermined width, places the segments one over another in a prescribed widthwise direction of the segments in the order, in which the document files are sorted according to the prescribed rule by means of the file sort section, so as to form a band-shaped configuration, and provides a classification color, which is associated with each document file by the color management section, to each corresponding segment thereby to create image data of a document map.

In addition, the present invention also resides in an electronic document management program adapted to make a computer achieve electronic document management, the program serving to make the computer achieve: a file sort function that reads individual document files from a plurality of document files storing electronic documents, and sorts the document files thus read according to a prescribed rule; a color management function that associates a classification color assigned corresponding to a group, to which each document file belongs, with document files which belong to that group; and a document map creation function that represents each document file by a segment of a predetermined length and of a predetermined width, places the segments one over another in a prescribed widthwise direction of the segments in the order, in which the document files are sorted according to the prescribed rule by means of the file sort function, so as to form a band-shaped configuration, and provides, for color representation instructed to document files, a classification color, which is associated with each document file by the color management function, to each corresponding segment thereby to create image data of a document map.

### BRIEF DESCRIPTION OF THE DRAWINGS

FIG. 1 is a block diagram that illustrates the construction of one embodiment of an electronic document control apparatus according to the present invention.

FIG. 2 is a view illustrating a file list of document files stored in the order of document IDs in a document storage section of the electronic document management apparatus of FIG. 1.

FIG. 3 is a view illustrating a state in which in case where files are sorted in the order of the latest last update dates in the file list of FIG. 2, an active color representation “True” is filled in all fields of representation when no condition is given to a condition input section.

FIG. 4 is a view illustrating a document file list in which when a character string “File 2” is provided as a condition input to the condition input section of FIG. 1, documents matching the condition are filled in with “True” in the column (fields) of representation, and documents unmatching the condition are filled in with “False”.

FIG. 5 is a view illustrating correspondence of colors (classification colors) assigned to respective paths shown in FIG. 2 through FIG. 4.

FIG. 6 is a view illustrating a file list in which color fields are filled in with classification colors that will be displayed based on the assignments of FIG. 5 if the fields of representation are all “True” in the case of the settings of the file list of FIG. 4.

FIG. 7 is a flow chart explaining operations of the embodiment of the electronic document management apparatus of the present invention.

FIG. 8 is a flow chart explaining in detail a document map creation operation among the operations shown in FIG. 7.

FIG. 9 is a view illustrating one example of each of a document map displayed on a display screen and a document file selected in the embodiment of the electronic document management apparatus of the present invention.

FIG. 10 is a view explaining a difference between an entire representation and a selective representation in the display screen shown in FIG. 9.

FIG. 11(A) is a view illustrating four classification colors “red, green, blue and purple” and one inactive color “gray”.

FIG. 11(B) is a view illustrating a document map of an entire representation when the classification colors of FIG. 11(A) are used.

FIG. 11(C) is a view illustrating the case where a selective representation of FIG. 11(B) is made.

### DESCRIPTION OF THE EMBODIMENT

Hereinafter, preferred embodiments of the present invention will be described in detail while referring to the accompanying drawings.

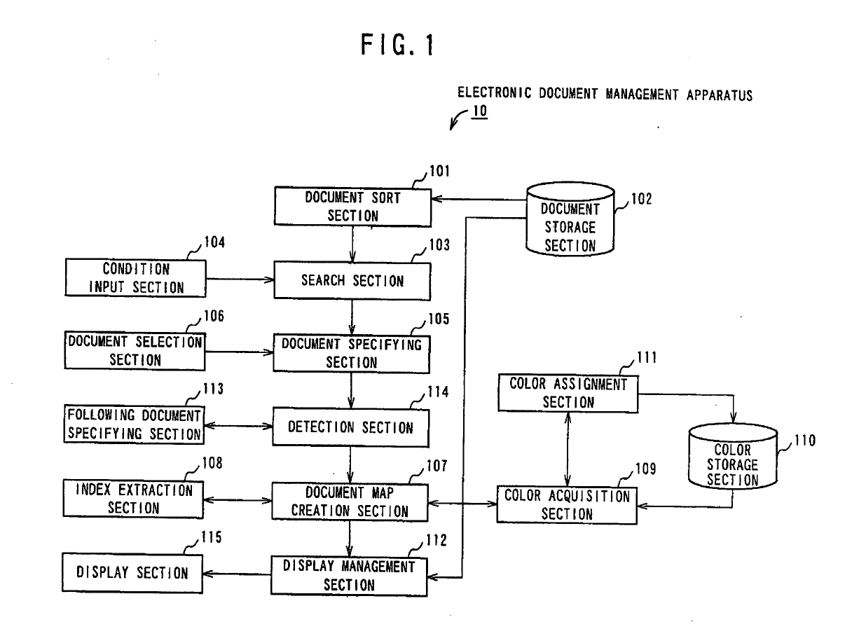

FIG. 1 is a block diagram that illustrates the construction of one embodiment of an electronic document management apparatus according to the present invention. The electronic document management apparatus 10 of FIG. 1 includes a document sort section 101, a document storage section 102, a search section 103, a condition input section 104, a document specifying section 105, a document selection section 106, a document map creation section 107, an index extraction section 108, a color acquisition section 109, a color storage section 110, a color assignment section 111, a display management section 112, a following document specifying section 113, a detection section 114, and a display section 115.

Here, the document sort section 101 constitutes a file sort section of the present invention; the search section 103 and the condition input section 104 together constitute a condition setting section of the present invention, the color acquisition section 109, the color storage section 110 and the color assignment section 111 together constitute a color management section of the present invention; and the display management section 112 and the display section 115 together constitute an image display section of the present invention.

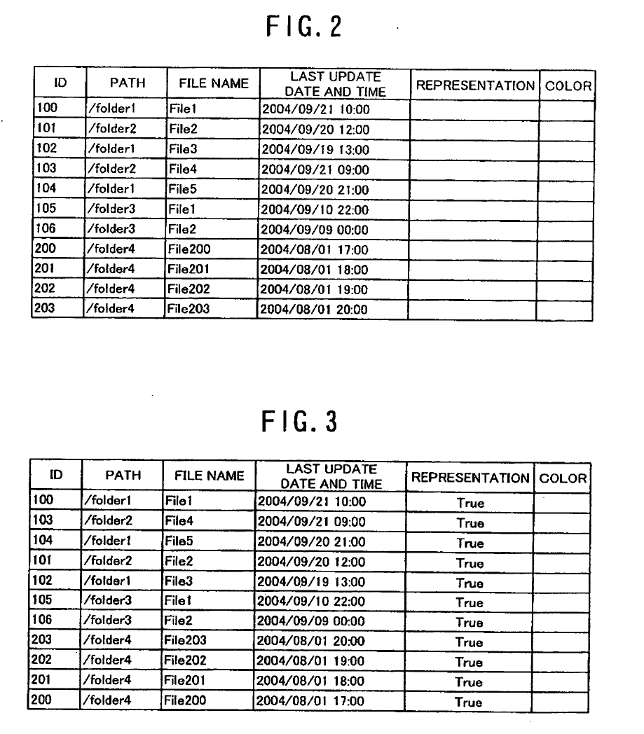

When the electronic document management apparatus 10 of FIG. 1 is activated, the document sort section 101 acquires and sorts list information (see FIG. 2) on electronic documents (hereinafter usually described as documents) registered (stored) in the document storage section 102. In this case, any sort method can be employed as such a sort method (sort rule) if users can understand the forward and backward or direction of an order. For example, though such methods as the file size, the number of pages, the number of characters, the number of updates, etc., can be considered, in this example, document files are sorted in the order of the latest to earliest last update dates by using the last update dates and times of the document files (see FIG. 3). The document sort section 101 delivers the file list thus sorted to the search section 103.

Though various methods such as a full text search, a file attribute-based search, a file type-based search, a file creator-based search, etc., are considered as a search method for searching files that belong to the same group (or classification), any search method can be applied if a subset is obtained from a universal set of the documents registered. Here, note that in this example, a search method according to a partial match of file names is used.

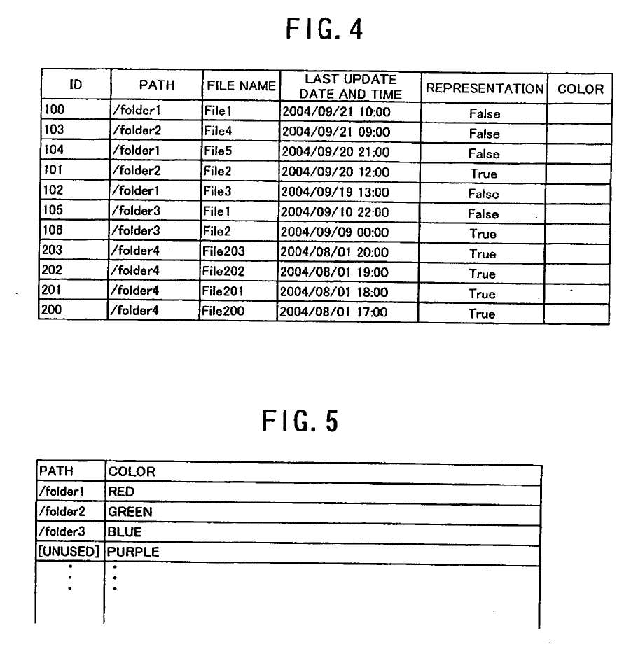

The search section 103 reads from the condition input section 104 a character string which becomes a part of a file name to be searched for. Here, when no character string is input to the condition input section 104, no search is executed, and all the documents to be searched are regarded as being matched (a state where “True” (active color representation) is filled in the column (fields) of “representation” of the file list; see FIG. 3). When a character string is input to the condition input section 104, the search section 103 checks the sorted file list received from the document sort section 101, and enters or writes “True” into items matching the condition of the input character string, and “False” (inactive color representation) into items unmatching the condition on the column of “representation”, respectively (see FIG. 4).

The search section 103 delivers the file list with “true” and “False” filled therein to the document specifying section 105. The document specifying section 105 reads out selection information on document files from the document selection section 106 (e.g., a mouse). When a selection of any document file has not yet been performed in the document selection section 106, the first or top document file in the file list (or a document at a position specified by another setting) is set as a current document. That is, as long as any segment in the document map has not yet been selected, one end of a segment with a classification color in the band-shaped document map is selected as the current document. When a selection of a document file has been performed in the document selection section 106, the document specifying section 105 reads out the document selection information from the document selection section 106 and specifies the document file thus selected. Though a variety of methods for specifying a document file can be considered, in this example, a position on the document map created by the document map creation section 107 and displayed on the display section 115 is designated by a coordinate input section such as a mouse, etc.

The document specifying section 105 interprets the coordinate information input from the document selection section 106, and calculates the distance from the top or uppermost portion of the document map to the position indicated by the coordinate information. The order of the selected document file from the document file on the top of the document map is calculated on the basis of the distance thus calculated. When the order of the selected document file is calculated, a corresponding document ID is acquired by referring to the file list so that the document file corresponding to the document ID is set as the current document. Information on the file list and the current document is delivered to the detection section 114. The detection section 114 acquires the value of the current document on the column of “representation” from the file list by using the document ID of the delivered current document, and if the value thus acquired is “True” (active color representation), the delivered current document is adopted, but if the acquired value is “False” (inactive color representation), the document ID of the current document and the file list is delivered to the following document specifying section 113. Accordingly, the following document specifying section 113 searches for a document file which is the nearest to the current document in the sorted order, and which has “True” (active color representation) in the value on its column of “representation”, and replaces the document ID of the so far current document by the document ID of the document file thus searched out. That is, in case where ones with and without classification colors in the displayed document map are displayed, when a segment without any classification color is selected, the position of selection is moved therefrom to a new position in which a segment with a classification color existing at the shortest distance to the selected segment is freshly selected.

After the above-mentioned processing has been made, the detection section 114 delivers the document ID of the current document and the file list to the document map creation section 107. The document map creation section 107 delivers the file list to the index extraction section 108, and acquires index information from the index extraction section 108. In this example, an index (turn mark) is attached at the turn of a month to which the last update date belongs. The index extraction section 108 acquires the file list, searches for the turn of a month in the order from the top, and returns the positions of all indexes searched or found and the figures indicative of months between adjacent indexes to the document map creation section 107. The document map creation section 107 delivers the file list to the color acquisition section 109. According to presettings (for example, see FIG. 5), the color acquisition section 109 writes color information on classification colors assigned to respective groups of document files into the color fields of the received file list.

Although in this example, paths in the file list are used as classifications for grouping, such classifications can be set based on classification codes attached upon registration of document files by someone, or based on the creators of files, methods of acquisition thereof, or the like. For example, any information, if being of the type in which the same value can be attached to one or more files, such as files contained in the same folder, files having the same attribute, files with the same extension attached or the like can be regarded as classifications. That is, generalizing about document files, it is necessary to set a plurality of document files in such a manner that they can be classified into a plurality of groups according to the features possessed by electronic documents respectively stored therein, and can be arranged or sorted in the order following a prescribed rule.

The color acquisition section 109 reads out color information from the color storage section 110, and if there exists any matched path, enters or writes a corresponding classification color into the file list. When a path not recorded in the color storage section 110 appears in the file list, the color acquisition section 109 passes the path to the color assignment section 111 and assigns a new color to the path. When the new path is received, the color assignment section 111 searches for an unassigned color by referring to the color storage section 110, and performs color assignment by writing the path into the unassigned color. The color assignment section 111 returns the unassigned color to the color acquisition section 109. When the received color has been written or filled into the file list, the color acquisition section 109 returns the file list with color information filled therein to the document map creation section 107. Here, note that though in the above case, the color storage section 110 and the document storage section 102 are illustrated separately from each other, different areas in the same storage medium can be used for them, respectively.

Upon receipt of the file list in which color information on the classification colors is written, the document map creation section 107 creates image data of the document map that has a striped pattern formed according to the orders and classification colors of the files in the file list. That is, each document file is represented by a segment of a predetermined length and of a predetermined width, and respective segments are closely placed in connection with one another in a prescribed widthwise direction of each segment in the order according to a prescribed rule (in this example, arranged or sorted in the latest order of the last update dates of the document files) so as to form a band-shaped configuration. A color assigned corresponding to each group of document files is provided to each of segments for the files, thus creating image data of the document map. In this case, the image data is constructed in such a manner that when “True” is filled in the fields of representation of the file list, a classification color is given so as to indicate a remarkable active color representation, whereas when “False” is filled therein, an unremarkable inactive color (e.g., gray) is given. Here, note that the inactive color can be represented by a plurality of colors.

The document map creation section 107 adds a sign (turn mark) representing the turn of a month and a number or figure representing the month to the image data thus created at a location received from the index extraction section 108, and at the same time applies a sign representing the current position (selected position mark) to a location corresponding to the current document received from the document specifying section 105. The document map creation section 107 delivers the image data of the document map as constructed above and the document ID of the current document to the display management section 112. The display management section 112 acquires the document data of the current document from the document storage section 102 by using the document ID, creates image data of the document from the acquired document data, and delivers it to the display section 115 together (in parallel) with the image of the document map, so that the document and the document map are displayed on the display section.

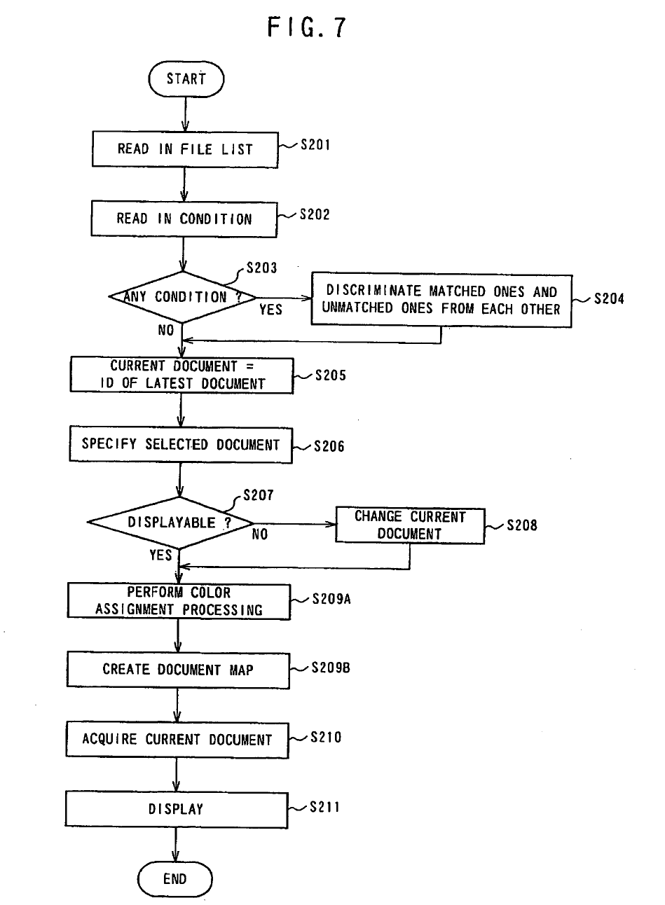

Next, an example of operations of the electronic document management apparatus 10 as illustrated in FIG. 1 will be described while referring to a flow chart in FIG. 7. When the electronic document management apparatus 10 is activated, the document sort section 101 reads in a file list (see FIG. 2) of the registered documents (electronic documents) stored in the document storage section 102 (S201), sorts the list in the latest order of the last updated dates, and enters or writes “True” in the column of “representation” of the file list as an initial value (FIG. 3). After step S201, the search section 103 reads in a search condition from the condition input section 104 (S202), and determines whether there is any condition or not (S203). When there is a condition, “False” is filled or written in the column of “representation” of the file list unmatching the condition (S204), so as to discriminate or classify the files matching the condition and those unmatching the condition from one another. In addition, when the condition is “empty” or there is no condition, the control process shifts to step S205 without doing anything (the column of “representation” being all “True”). FIG. 4 illustrates the state of the file list after the processing in step S204 has been done in case where the search condition read in step S202 is “File 2”.

When a selection of any document file by the document selection section 106 such as a mouse or the like is not carried out in step S205, the document specifying section 105 specifies a document file on the top of the file list (e.g., the latest one, but can be another one such as an intermediate one, depending on settings) as the current document (an automatic selection; S205), whereas when an ordinary selection of a document file is made by the document selection section 106, the selected document file is specified as the current document, and the current document is updated (S206). The file list is then verified based on the document ID of the current document thus specified, so that it is determined whether it is possible to display the current document (which one of “True” and “False” has been filled in the column of “representation” ?)(S207). If it is possible to display (“True”), the control process shifts to step S209A without doing anything, whereas if “False” is filled therein (S207—NO) a document file, which can be displayed (“True” and which has a document ID nearest in the sorted order to the document ID of the current document, is set as the current document by referring to the file list (S208), and the control process shifts to the following step. In the following step, color assignment processing is carried out by the color assignment section 111 (S209A), and image data for the document map is created by the document map creation section 107 while using information on the file list, etc (S209B). Thus, the display image of the current document is acquired (S210), and the document map and the display image of the document are displayed together (S211).

In the operations of FIG. 7, the step S201 constitutes a file sort step of the present invention, and the steps S202, 203 and 204 together constitute a condition selection step of the present invention. Also, the step S209A constitutes a color management step, and the step S209B constitutes a document map creation step of the present invention.

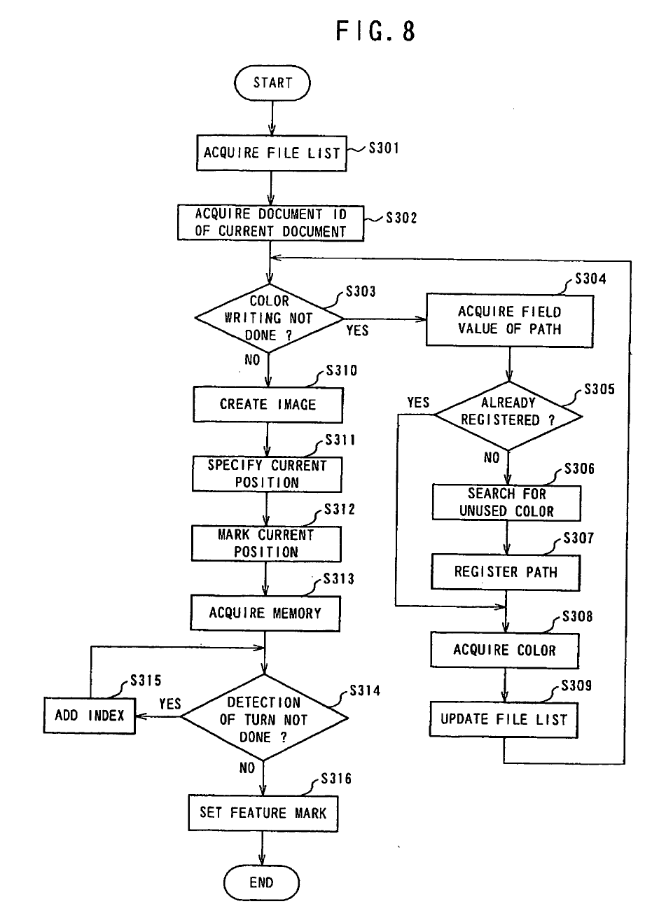

An example of the operation of the image data creation for the above document map will be described in detail by further referring to a flow chart in FIG. 8. The document map creation section 107 acquires the file list (see FIG. 4) in which the result of a search conducted based on a search condition is filled (S301), and acquires the document ID of the current document (S302). The color fields of the file list are verified based on the document ID thus acquired, so that it is determined whether there is any unprocessed document file in which no classification color is filled in its color field (S303). When there are some unprocessed document files, one of the unprocessed document files is taken out, and the value of the field of the path of the document file is acquired (S304).

The value of the field of the path thus acquired and the color information (see FIG. 5) stored in the color storage section 110 are compared with each other, so it is determined whether the path of the document file has already been registered (S305). When already registered, a corresponding classification color is acquired (S308), whereas when not registered, an unused color with no color information path filled therein is searched (S306), and the current path is registered in the color information path (S307), after which the control process shifts to step S308 where a corresponding classification color is acquired. After the classification color has been acquired in step S308, the acquired classification color is entered or written into a corresponding location of the file list (update the file list: S309), and a return to step S303 is carried out.

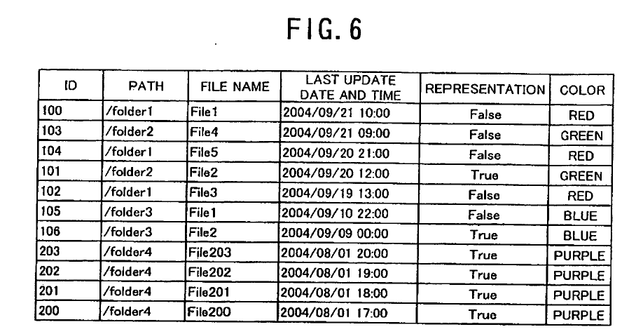

When it is detected in step S303 that there is no one with color writing unprocessed, as shown in FIG. 6, image data for the document map (bitmap image) is created according to the order of the files in the file list (S310). Further, the order of the current document file appearing from the top of the file list is calculated and specified based on the document ID of the current document (S311), so that a current position sign (selected position mark) is written in the document map at a corresponding position thereon (S312). In addition, the turn of the first month is detected from the file list, and an index therefor (turn mark) is acquired (S313), so that a determination is made as to whether there is any unprocessed detection for the turns of all the past months to be searched (S314). If there is any unprocessed detection, the processing of adding a new index (turn mark) is performed (S315), whereas if there remains no unprocessed detection, a feature mark, which indicates the feature of document files existing between adjacent turn marks, is superposed on the image data of the document map between the adjacent turn marks (S316). In this case, if the position of a turn is, for example, a position at which a month to which the last update dates and times of the document files belong turns or changes, a number or figure representing the month can be considered as such a feature mark. After the above processing has been completed, the operation of FIG. 8 is terminated.

In the operation shown in FIG. 8, the steps S301 through S309 correspond to a color management step (color assignment step) of the present invention, and the steps S301 through S303 and the steps S310 through S312 correspond to a document map creation step of the present invention, and the step S311 and the steps S313 through S315 correspond to an image display step of the present invention.

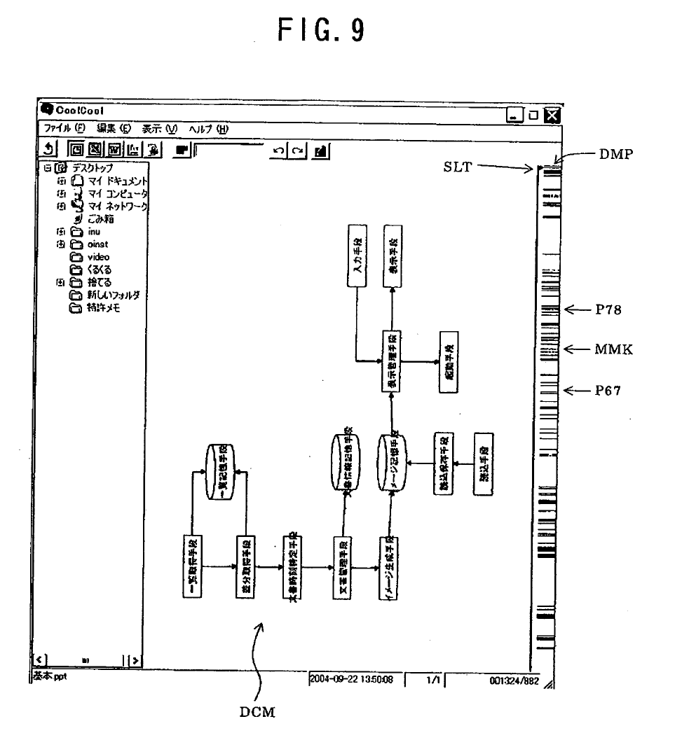

Finally, the above-mentioned operations will be summarized referring to FIG. 6 and FIG. 9 through FIG. 11. When a file list is determined as shown in FIG. 6, a document map DMP and a document DCM are displayed in parallel with each other based on the file list thus determined, as illustrated in FIG. 9 for instance. In this document map DMP, each document file is represented by a segment of a predetermined length and of a predetermined width, and respective segments are closely placed one over another in a prescribed widthwise direction of each segment to form a band-shaped configuration in such a manner that document files of newer or later update dates are arranged at the upper positions. Additionally, a color assigned corresponding to each group of document files is provided to each of segments for the files.

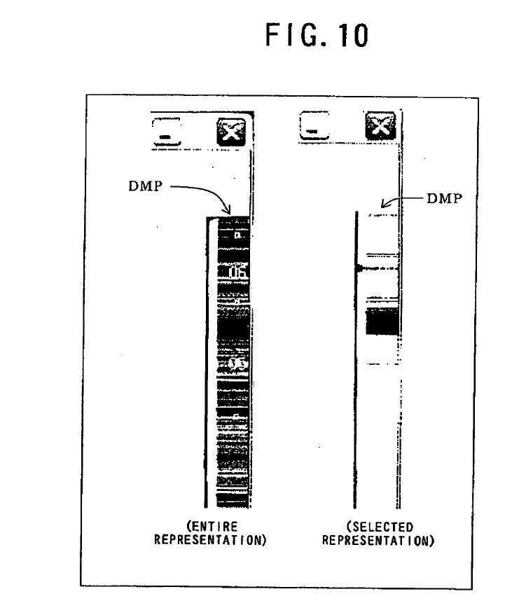

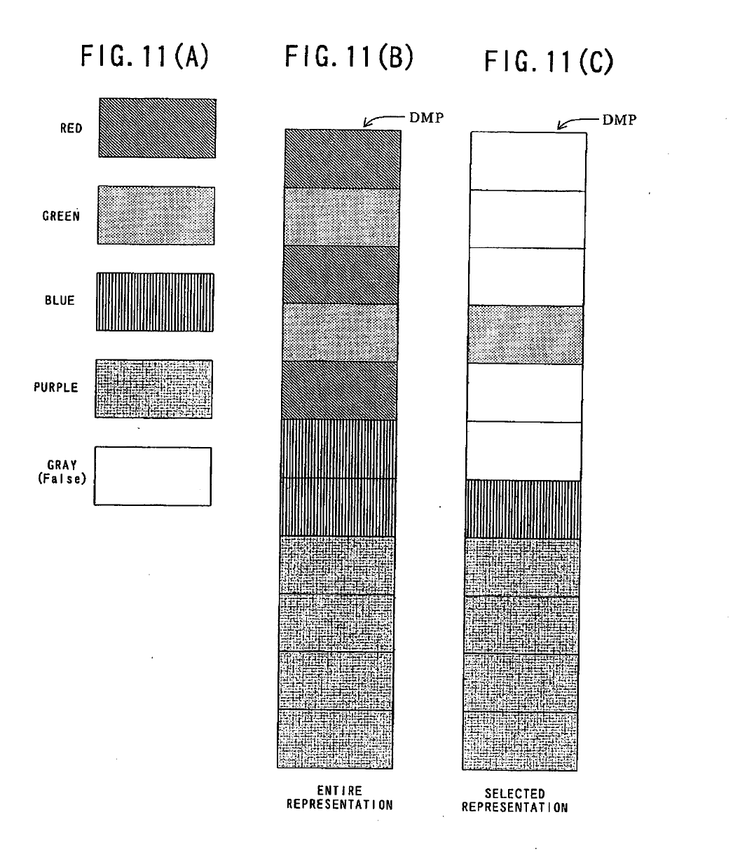

In the above case, in FIG. 9, unlike the contents of FIG. 6, the segments corresponding to all the document files are displayed (all displayed) with colors (classification colors). As can be seen from reference to FIG. 6, an example of a selective representation with “True” and “False” filled in the fields of representation is illustrated in FIG. 6, and in such a case, in FIG. 9, inactive colors such as unremarkable colors, for example, gray, etc., are given to segments for document files corresponding to “False” so as to indicate that no classification color is provided to these segments. Although FIG. 10 illustrates a difference between the all or entire representation and the selective representation, but displaying with colors attached is impossible, so it is illustrated like in FIG. 11 if represented simulationally by figures and characters. In FIG. 11(A), when “True” is filled in the fields of representation, colors (classification colors) to be displayed corresponding to the classifications of the document files are illustrated as “red, green, blue, and purple”, whereas when “False” is filled in the fields of representation, “gray” (in actuality, void) is illustrated to indicate that a color to be displayed is not a classification color. In addition, the case of an all or entire representation using these colors is illustrated in FIG. 11(B), and the case of a selective representation is illustrated in FIG. 11(C).

Moreover, a selected position mark SLT is displayed on an upper left side of the document map DMP in FIG. 9. This position is designated, for example, by a mouse or the like. FIG. 9 illustrates the case of the all or entire representation in which the front page of a document file corresponding to a segment lying at the location of the selected position mark SLT is displayed as an initial representation of the document DCM. The representation of the document DCM can be moved to any of the other pages thereof according to an instruction. Additionally, turn marks P67, P78 are shown on the document map DMP.

These marks indicate the turns of months, and a number or figure representative of a month is shown at an intermediate position MMK between the turn marks so as to facilitate searches.

As described in detail above, according to the embodiment of the present invention, by creating a document map, document files, which were read out from the document storage section and sorted according to a prescribed rule by means of the file sort section, are represented by prescribed segments, respectively, and these segments are appropriately connected with one another to form the band-shaped document map, and classification colors assigned by the color management section can be provided to the respective segments. In this case, any classification color is not provided to the segments of those document files for which an instruction for an inactive color representation is given by the condition setting section, but an inactive color is instead provided thereto. Accordingly, one can easily understand, with the colors and amounts or lengths of segments, how the entire document files of each group exist in a visual manner. In addition, by performing a condition setting, only a desired group can be extracted and displayed, so it is easy to search for a target document file. Moreover, the document file corresponding to a segment selected on the document map can also be displayed, so the content of the document file can be easily confirmed.

Although in the embodiment of the present invention, functions for realizing the present invention are recorded beforehand in the interior of the apparatus, the present invention is not limited to this but similar functions can be downloaded into the apparatus via a network, or a computer-readable recording medium storing therein similar functions can be installed in the apparatus. Such a recording medium can be of any form such as a CD-ROM, which is able to store programs and which is able to be read out by the apparatus. In addition, the functions to be obtained by such preinstallation or downloading can be achieved through cooperation with an OS (operating system) or the like in the interior of the apparatus.

What is claimed is:

1. An electronic document management apparatus comprising:
a file sort section that reads individual document files from a plurality of document files storing electronic documents, and sorts the document files thus read according to a prescribed rule:
a color management section that associates a classification color assigned corresponding to a group, to which each document file belongs, with document files which belong to that group; and
a document map creation section that represents each document file by a segment of a predetermined length and of a predetermined width, places said segments one over another in a prescribed widthwise direction of said segments in the order, in which said document files are sorted according to said prescribed rule by means of said file sort section, so as to form a band-shaped configuration, and provides a classification color, which is associated with each document file by said color management section, to each corresponding segment thereby to create image data of a document map.

2. The electronic document management apparatus according to claim 1, further comprising: an image display section that displays said document map on a portion of a display screen by using the image data of said document map created by said document map creation section.

3. The electronic document management apparatus according to claim 2, wherein when any segment of a classification color in said document map displayed is selected, said image display section displays a document file corresponding to said selected segment on said display screen as a current document together with said document map.

4. The electronic document management apparatus according to claim 1, further comprising a condition setting section that associates an instruction for an active color representation or an inactive color representation with each document file, wherein when an inactive color representation is instructed to a document file, said document map creation section provides a preset inactive color to a segment for that document file, whereas when an inactive color representation is instructed, said document map creation section provides a classification color, which is associated with each document file by said color management section, to each corresponding segment, whereby the image data of said document map is created.

5. The electronic document management apparatus according to claim 3, wherein said image display section displays said document map in such a manner as to extend in a band shape along an edge of said display screen, and as long as any segment in said document map has not yet been selected, said image display section displays, as a segment for a current document, a segment of a classification color that lies at a prescribed location of said band-shaped document map.

6. The electronic document management apparatus according to claim 5, wherein said image display section displays a selected position mark at the position of said selected segment.

7. The electronic document management apparatus according to claim 3, wherein said image display section displays said document map in such a manner as to extend in a band shape along an edge of said display screen, and when any segment in said document map is selected, said image display section moves a selected position mark to the position of said selected segment.

8. An electronic document management program adapted to make a computer achieve electronic document management, said program serving to make said computer achieve:
a file sort function that reads individual document files from a plurality of document files storing electronic documents, and sorts the document files thus read according to a prescribed rule;
a color management function that associates a classification color assigned corresponding to a group, to which each document file belongs, with document files which belong to that group; and
a document map creation function that represents each document file by a segment of a predetermined length and of a predetermined width, places said segments one over another in a prescribed widthwise direction of said segments in the order, in which said document files are sorted according to said prescribed rule by means of said file sort function, so as to form a band-shaped configuration, and provides, for color representation instructed to document files, a classification color, which is associated with each document file by said color management function, to each corresponding segment thereby to create image data of a document map.

9. The electronic document management program according to claim 8, further making said computer achieve an image display function that displays said document map on a portion of a display screen by using the image data of said document map created by said document map creation function.

10. The electronic document management program according to claim 9, wherein when any segment of a classification color in said document map displayed is selected, said image display function serves to make said computer display a document file corresponding to said selected segment on said display screen as a current document together with said document map.

11. The electronic document management program according to claim 8, further comprising a condition setting function that associates an instruction for an active color representation or an inactive color representation with each document file, wherein said document map creation function serves to make said computer achieve that when an inactive color representation is instructed to a document file, a preset inactive color is provided to a segment for that document file, whereas when an active color representation is instructed, a classification color, which is associated with each document file by said color management function, is provided to each corresponding segment, whereby the image data of said document map is created.

12. The electronic document management program according to claim 10, wherein said image display function serves to make said computer achieve that said document map is displayed in such a manner as to extend in a band shape along an edge of said display screen, and as long as any segment in said document map has not yet been selected, a segment of a classification color lying at a prescribed location of said band-shaped document map is displayed as a segment for a current document.

13. The electronic document management program according to claim 12, wherein said image display function serves to make said computer achieve that a selected position mark is displayed at the position of said selected segment.

14. The electronic document management program according to claim 12, wherein said image display function serves to make said computer achieve that as long as any segment in said document map has not yet been selected, either one of segments, which lie at locations nearest to either end of said band-shaped document map and have a classification color, is selected as a segment for a current document.

15. The electronic document management program according to claim 10, wherein said image display function serves to make said computer achieve that said document map is displayed in such a manner as to extend in a band shape along an edge of said display screen, and when any segment in said document map is selected, said selected position mark is moved to the position of said selected segment.

16. The electronic document management program according to claim 9, wherein said document map creation function serves to make said computer achieve that a prescribed position in each document file in the document map is extracted, and a mark indicative of said prescribed position is superposed on said extracted position.

17. The electronic document management program according to claim 9, wherein said document map creation function serves to make said computer achieve that a position at which a feature of each document file turns is extracted as a prescribed position in that document file, and a turn mark indicative of a turn is superposed on the extracted position, and a feature mark, which indicates the feature of each document file existing between adjacent turn marks, is superposed on said document map between the adjacent turn marks.

18. The electronic document management program according to claim 17, wherein said order according to said prescribed rule is an order from the latest to earliest of the last update dates and times of the document files, and said position of a turn is a position at which a month to which the last updated date and time of each document file belong changes, and said feature mark is a figure indicative of the month.

19. The electronic document management program according to claim 15, wherein in case where ones with and without classification colors in said displayed document map are displayed, when a segment without any classification color is selected, said image display function serves to make said computer achieve that the selection is moved to a segment with a classification color existing at the shortest distance to said selected segment.

20. The electronic document management program according to claim 15, wherein in said color management function, said computer is made to achieve that when a document file of a group to which a classification color corresponding to any group of document files has not yet been assigned is read out, one color is selected from among colors provided as unassigned classification colors, and assigned as a classification color for the group of said document file read out.
